(19) United States
(12) Patent Application Publication
(10) Pub. No.: US 2025/0313129 A1
(43) Pub. Date: Oct. 9, 2025

(54) CONTROL METHOD FOR CONDITIONING A BATTERY IN A MOBILITY APPARATUS AND A MOBILITY APPARATUS CONTROLLING A BATTERY CONDITIONING ACCORDING TO THE SAME

(71) Applicants: HYUNDAI MOTOR COMPANY, Seoul (KR); KIA CORPORATION, Seoul (KR)

(72) Inventor: Jae Woo JEON, Hwaseong-si (KR)

(73) Assignees: HYUNDAI MOTOR COMPANY, Seoul (KR); KIA CORPORATION, Seoul (KR)

(21) Appl. No.: 18/955,375

(22) Filed: Nov. 21, 2024

(30) Foreign Application Priority Data
Apr. 8, 2024 (KR) 10-2024-0047311

(51) Int. Cl. B60L 58/22; B60L 15/00; B60L 53/80; B60L 58/12

(52) U.S. Cl. CPC B60L 58/22; B60L 15/007; B60L 53/80; B60L 58/12; B60L 2210/10

(57) ABSTRACT

A mobility apparatus includes a plurality of first wheels, at least one first driving motor for providing a driving force to the plurality of first wheels, a power system including a first battery for supplying power to the at least one first driving motor, and a controller for controlling the at least one first driving motor and the power system. A control method for conditioning a battery of the mobility apparatus includes: when a second battery is detachably and electrically connected to the power system, determining, by the controller, whether the first battery and the second battery require conditioning; determining, by the controller, conditioning time points of the first battery and/or the second battery according to whether the first battery and the second battery require the conditioning, and performing, by the controller, the conditioning of the first battery and/or the second battery.

### CROSS-REFERENCE TO RELATED APPLICATION

This application claims priority to Korean Patent Application No. 10-2024-0047311, filed on Apr. 8, 2024, the entire contents of which are incorporated herein by reference.

### TECHNICAL FIELD

The present disclosure relates to a control method for conditioning a battery in a mobility apparatus and a mobility apparatus.

### BACKGROUND

In general, an electric vehicle, a type of mobility apparatus, is operated with wheels driven by the driving force of a driving motor.

Typically, a high-voltage battery is fixedly mounted in a vehicle to supply power to a driving motor.

The driving motor may be an AC motor and an inverter may be included between a battery and a driving motor.

According to a charging status, which is a State of Charge (SOC), when charging is required, a battery of an electric vehicle may be charged by receiving external power through an onboard charger (OBC).

A charging time may be determined according to charging methods, including slow charging and fast charging.

With the continuous research and development on batteries, the driving distance per one charging has greatly improved recently.

However, the battery fixedly mounted in an electric vehicle may not be sufficient, and thus alternative is needed.

The statements in this Background section merely provide background information related to the present disclosure and may not constitute prior art.

### SUMMARY

The present disclosure is provided to alleviate or solve the above-described conventional problems.

The present disclosure aims to provide a new concept of technology that uses a second high-voltage battery added to or detached from the power system of an electric vehicle when necessary in addition to a first high-voltage battery preset in the electric vehicle.

In addition, an embodiment of the present disclosure is provided to enhance a State of Health (SoH) by effectively performing the conditioning of batteries such as use, charging, or replacement in a dual battery system.

An embodiment of the present disclosure is provided to improve the conditioning efficiency by using a battery in use or in charging to perform conditioning of another battery in a dual battery system.

According to an embodiment of the present disclosure, a method for conditioning a battery of a mobility apparatus including a plurality of wheels, at least one driving motor for providing a driving force to the plurality of wheels, a power system including a first battery for supplying power to the at least one driving motor, and a controller for controlling the at least one driving motor and the power system is provided. The method includes: determining, by the controller, whether the first battery and a second battery detachably and electrically connected to the power system require conditioning; determining, by the controller, one or more conditioning time points of the first battery and/or the second battery based on a determination of whether the first battery and the second battery require the conditioning; and performing, by the controller, the conditioning of the first battery and/or the second battery, wherein performing the conditioning of the first battery and/or the second battery includes transmitting a control signal to a first conditioning device and/or a second conditioning device.

Determining whether the first battery and the second battery require the conditioning may be performed based on at least one of charging due information of the first battery, charging due information of the second battery, SoC information of the first battery, SoC information of the second battery, or replacement due information of the second battery.

Determining whether the first battery and the second battery require the conditioning may include a first step of determining whether the first battery and the second battery require the conditioning based on a result of comparison between a SoC of the first battery and a SoC of the second battery.

Determining whether the first battery and the second battery require the conditioning may further include a second step of determining whether the first battery and the second battery require the conditioning based on a result of comparison between the SoC of the second battery and a first preset SoC when the SoC of the first battery is equal to or less than the SoC of the second battery.

Determining whether the first battery and the second battery require the conditioning may further include a third step of determining whether the second battery requires the conditioning based on the replacement due information of the second battery.

Determining whether the first battery and the second battery require the conditioning may include obtaining the charging due information based on a navigation device or a user input.

Determining whether the first battery and the second battery require the conditioning may further include determining that the first battery requires conditioning when the first battery is due for charging, and determining that the second battery requires the conditioning when the second battery is due for charging.

Determining whether the first battery and the second battery require the conditioning may include determining a first conditioning flag for the first battery and/or a second conditioning flag for the second battery differently based on the charging due information, the SoC information, and the replacement due information.

Performing the conditioning may include transmitting the control signal including the first conditioning flag and/or the second conditioning flag.

The second battery may be detachably and electrically connected to the first battery through a DC/DC converter.

According to an embodiment of the present disclosure, a mobility apparatus, including a plurality of wheels, at least one driving motor configured to provide a driving force to the plurality of wheels, a power system including a first battery for providing power to the at least one driving motor, and a controller configured to control the at least one driving motor and the power system is provided. When a second battery is detachably and electrically connected to the power system, the controller is configured to determine whether the first battery and the second battery require conditioning, determine one or more conditioning time points of the first battery and/or the second battery based on a determination of whether the first battery and the second battery require the conditioning, and perform the conditioning of the first battery and/or the second battery by transmitting a control signal to a first conditioning device or a second conditioning device.

The controller may be configured to determine whether the first battery and the second battery require the conditioning based on at least one of charging due information of the first battery, charging due information of the second battery, SoC information of the first battery, SoC information of the second battery, or replacement due information of the second battery.

In determining whether the first battery and the second battery require the conditioning, the controller may be further configured to determine whether the first battery and the second battery require conditioning based on a result of comparison between a SoC of the first battery and a SoC of the second battery.

In determining whether the first battery and the second battery require the conditioning, the controller may be further configured to determine whether the first battery and the second battery require the conditioning based on a result of comparison between the SoC of the second battery and a first preset SoC when the SoC of the first battery is equal to or less than the SoC of the second battery.

In determining whether the first battery and the second battery require the conditioning, the controller may be further configured to determine whether the second battery requires conditioning based on the replacement due information of the second battery.

In determining whether the first battery and the second battery require the conditioning, the controller may be further configured to obtain the charging due information based on a navigation device or a user input.

In determining whether the first battery and the second battery require the conditioning, the controller may be further configured to determine that the first battery requires the conditioning when the first battery is due for charging, and determine that the second battery requires the conditioning when the second battery is due for charging.

In determining whether the first battery and the second battery require the conditioning, the controller may be further configured to determine a first conditioning flag for the first battery and/or a second conditioning flag for the second battery differently according to the charging due information, the SoC information, and the replacement due information.

In performing the conditioning, the controller may be further configured to transmit a control signal including the first conditioning flag and/or the second conditioning flag.

The second battery may be detachably and electrically connected to the first battery through a DC/DC converter.

The present disclosure is provided to increase the driving distance of an electric vehicle and improve usability by detachably connecting a second high-voltage battery to the power system of the electric vehicle.

According to an embodiment, the SoH of the battery may be maximized with the optimized conditioning by specifying the conditioning status required for the battery based on the intention of the driver to charge the battery and navigation information.

In addition, conditioning efficiency may be improved by using a battery in use (e.g., driving or charging) for conditioning a battery that is not used.

### BRIEF DESCRIPTION OF DRAWINGS

FIG. 1 is a view illustrating a power system of a first mobility apparatus according to an embodiment of the present disclosure;

FIG. 2 is a view illustrating that a first mobility apparatus is connected to a second mobility apparatus according to an embodiment of the present disclosure;

FIG. 3 is a view illustrating a signal connection relationship of a first controller, battery management system (BMS), and conditioning devices according to an embodiment of the present disclosure;

FIG. 4 is a view illustrating a decision process of a conditioning status flag according to an embodiment of the present disclosure;

FIG. 5 is a view illustrating a conditioning control process according to an embodiment of the present disclosure; and

FIG. 6 is a view illustrating a simulation of a conditioning process according to an embodiment of the present disclosure.

The drawings described herein are for illustration purposes only and are not intended to limit the scope of the present disclosure in any way.

### DETAILED DESCRIPTION

While embodiments are described with reference to the accompanying drawings, it should be understood that various changes and modifications may be made in the present disclosure. Further, it should be understood that the present disclosure is not limited to the specific embodiments thereof, and various changes, equivalences, and substitutions may be made without departing from the scope and spirit of the present disclosure.

In embodiments of the present disclosure, terms such as “module”, “unit”, “part”, and the like are terms used for nominal distinct between components, and it should not be interpreted as assuming that they are physically and chemically separated or capable of being separated or divided.

Terms containing ordinal numbers, such as “first”, “second”, and the like, may be used to describe various components, but the components are not limited by the terms. These terms may be used only in a nominal sense to differentiate one component from another component, and their mutual sequential meaning should be understood through the context of the corresponding description, not through such terms.

The term “and/or” is used to include all instances of any combination of multiple items being the subject. For example, “A and/or B” includes all three cases: “A”, “B”, and “A and B”.

When a component is used to be “coupled” or “connected” to another component, it should be understood that the component may be either connected directly to another component, or connected indirectly via another medium.

The terms in the present application are used to describe an embodiment and do not intend to restrict and/or limit the present disclosure. Singular forms are intended to include plural forms unless the context clearly indicates otherwise. According to an embodiment of the present disclosure, terms such as “comprise,” “include,” “have,” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

Unless otherwise defined, all terms used in embodiment of the present disclosure including technical or scientific terms, have the same meaning as generally understood by a person having ordinary skill in the technical field to which the present disclosure pertains. Terms defined in commonly used dictionaries should be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” are only widely used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, and the like, and at least one or more of processor that performs determination, calculation, decision, and the like used to control the corresponding function. When a component, controller, processor, module, unit, part, device, element, apparatus, or the like of the present disclosure is described as having a purpose or performing an operation, function, or the like, the component, controller, processor, module, unit, part, device, element, apparatus, or the like should be considered herein as being “configured to” meet that purpose or to perform that operation or function. Each component, controller, processor, module, unit, part, device, element, apparatus, and the like may separately embody or be included with a processor and a memory, such as a non-transitory computer readable media, as part of the apparatus.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an application-specific integrated circuit (ASIC), and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

An embodiment of the present disclosure is explained with reference to the drawings.

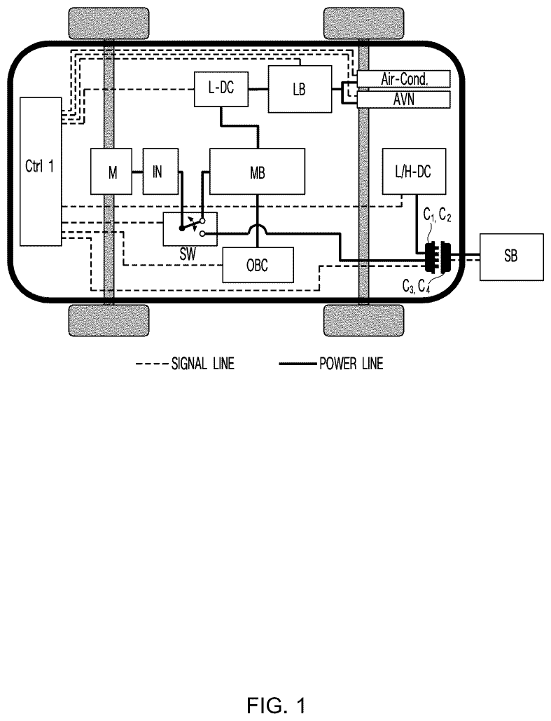

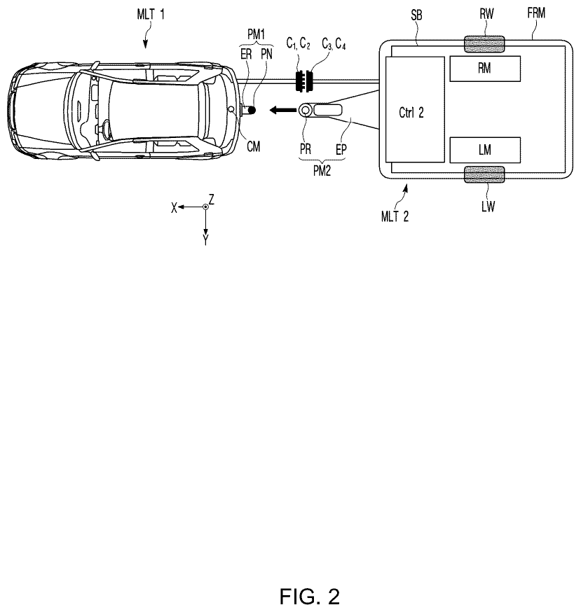

FIG. 1 is a schematic view illustrating a power system of a first mobility apparatus MLT 1 (e.g., an electric vehicle), and FIG. 2 is a view illustrating that a second mobility apparatus MLT 2 is connected to the first mobility apparatus MLT 1.

Referring to FIGS. 1 and 2, the respective structures of the first mobility apparatus MLT 1 and the second mobility apparatus MLT 2 are described according to an embodiment.

Referring to FIG. 1, the first mobility apparatus MLT 1 according to an embodiment may be, for example, an electric vehicle, including a first driving motor M, an inverter IN, a first high-voltage battery MB, an on-board charger OBC, a first DC/DC converter L-DC, a low-voltage battery LB, an air conditioning equipment Air-cond that operates at a low-voltage, an Audio Video Navigation (AVN), a second DC/DC converter L/H-DC, a switch SW, and a controller (referred to as a first controller).

The first driving motor M may provide a driving force to the wheels of the vehicle, and the first driving motor M may be an alternating current motor.

The inverter IN may invert a direct current power supplied to the first driving motor M to an alternating current.

The first high-voltage battery MB may be fixedly provided in the body of the first mobility apparatus MLT 1, for example, under the bottom of a vehicle cabin.

The first high-voltage battery MB may mainly supply electric power to the first driving motor M, and may be charged with the onboard charger OBC.

The first high-voltage battery MB may be connected to the low-voltage battery LB through the first DC/DC converter L-DC to charge the low-voltage battery LB.

The first DC/DC converter L-DC may be a step-down DC/DC converter (LDC; low-voltage DC-DC converter) to charge the low-voltage battery LB.

The low-voltage battery LB may be, for example, a battery of 12V or 24V, and may supply electric power to electric devices in the vehicle such as the air conditioning equipment, the AVN, and the like that operate at a low voltage.

The second high-voltage battery SB in FIG. 1 may be provided in the second mobility apparatus MLT 2, but the present disclosure is not limited thereto. For example, the second high-voltage battery SB may be detachably placed in the first mobility apparatus.

The second high-voltage battery SB may be electrically connected in a wired method (or in a wireless method in a range possible) to the vehicle power system including the first high-voltage battery MB as an additional in a way that the second high-voltage battery SB may not affect the operation of the power system (power supply to vehicle electronics, a driving motor, and the like).

The second high-voltage battery SB may be a replaceable battery, an auxiliary battery, an extended battery, or a secondary battery, but this is only for distinction from the first high-voltage battery MB. In other words, the second high-voltage battery SB may not be limited by the name with functions, characteristics, relationships with other objects (the first high-voltage battery MB, a host vehicle, and the like), or its own mechanical/electrical/chemical structure, battery type (types of packaging method, anode material/cathode material/separator material, and the like), charging method, and the like.

The second high-voltage battery SB may be connected wirely or wirelessly with the first controller Ctrl 1 of the first mobility apparatus MLT 1, or a battery management system (BMS) of the first high-voltage battery MB, and various sensing information (e.g., voltage, current, temperature, and the like) related to the SOC state, physical/electrical/chemical status of the second high-voltage battery SB may be transmitted to the first controller Ctrl 1. However, the present disclosure is not limited thereto, but the information on the second high-voltage battery SB may be transmitted to the first controller Ctrl 1 through a second controller Ctrl 2 of the second mobility apparatus MLT 2.

According to an embodiment, a high-voltage battery applied to the first high-voltage battery MB and the second high-voltage battery SB may include, for example, a plurality of battery cells (not shown) that output a voltage of 2.7 to 4.2 V, and the plurality of battery cells may be connected in series/parallel to each other in a preset number to form a single module. The high-voltage battery may be packaged in one battery package with one or more battery modules connected in series/parallel to output a desired output voltage, for example, approximately 400 V, 800 V, or several kV.

The first high-voltage battery MB and the second high-voltage battery SB each may include the battery management system (BMS).

The BMS may include a battery management unit (BMU), a cell monitoring unit (CMU), and a battery junction box (BJB).

The BMS may perform a cell balancing function to ensure the performance of the entire battery pack by constantly maintaining the voltage of each cell, a State of Charge (SoC) function to calculate the capacity of the entire battery system, battery cooling, charging, discharging control, and the like.

The BMU may receive information on all cells from the CMU and perform the functions of the BMS based on the information.

The BMU may consist of, for example, two (2) micro-control units MCU, and each MCU may include a single CAN communication port. The MCU may include a CAN interface to communicate with a vehicle controller which is the upper-level device of the BMS, and a CAN interface for collecting the information of the CMU which is the lower-level device.

The CMU may be directly attached to a battery cell to perform sensing of voltage, current, temperature, and the like. The CMU may not perform calculations related to BMS algorithms but may perform sensing. A plurality of battery cells may be connected to a single CMU, and information on each cell may be transmitted to the BMU through the CAN interface.

The BJB may be a pack-level detection mechanism of the BMS and a connection medium between a high-voltage battery and a drivetrain. The BJB may measure and record a battery voltage and a current flowing inside and outside the battery to accurately calculate the SoC. The BJB may perform important functions to safety such as overcurrent detection, insulating monitoring, and the like.

The second high-voltage battery SB may be a high-voltage battery lower than the first high-voltage battery MB, and the second DC/DC converter L/H-DC may be a step-up DC/DC converter. The second high-voltage battery SB may be a high-voltage battery higher than the first high-voltage battery MB, and the second DC/DC converter L/H-DC may be a step-down DC/DC converter. According to an embodiment, the second DC/DC converter L/H-DC may be bidirectional. Therefore, the first high-voltage battery MB and the second high-voltage battery SB may charge and discharge each other.

According to an embodiment, the second DC/DC converter L/H-DC may be built in the first mobility apparatus MLT 1 in the power system but the present disclosure is not limited thereto. For example, unlike an embodiment of the present disclosure, the second DC/DC converter L/H-DC may be provided as a separate component and additionally and detachably connected to the power system. The second DC/DC converter L/H-DC may be built in or detachably placed in the second mobility apparatus MLT 2.

For the detachable electrical connection of the second high-voltage battery SB to the power system, the power system of the first mobility apparatus MLT 1 may include first and second connectors C1 and C2, and the second high-voltage battery SB may include third and fourth connectors C3 and C4.

For example, the first and second connectors C1 and C2 may be connectors in an integrated form, and the third and fourth connectors C3 and C4 also may be connectors in an integrated form.

The first connector C1 may be connected to the second DC/DC converter L/H-DC, and the second connector C2 may be connected to the switch SW.

Although not shown, a signal transmission connector may be added to transmit sensing and status information on the second high-voltage battery SB to the controller.

The switch SW may be fixedly and electrically connected to the inverter IN, and switched between the first high-voltage battery MB and the second connector C2 to connect the first high-voltage battery MB to the inverter IN or electrically connect the inverter IN to the second high-voltage battery SB.

According to an embodiment, the first high-voltage battery MB may be connected to the inverter IN through the switch SW, but the present disclosure is not limited thereto, and the first high-voltage battery MB may be directly connected to the inverter IN without the switch SW. In this case, the second connector and the fourth connector of the second high-voltage SB may not be necessary.

The first controller Ctrl 1 may be a vehicle controller of the highest level to control all electrical devices in the first mobility apparatus MLT 1, but the present disclosure is not limited thereto. For example, the first controller Ctrl 1 in FIG. 1 may be a power controller of the lower level from the vehicle controller.

According to an embodiment, the first controller Ctrl 1 may include a computer-readable recording medium that stores an operating system, logic commands, input/output information, and the like, and one or more processors that read the information to perform judgments, calculations, decisions, and the like.

The second high-voltage battery SB in FIG. 1 may be provided in the second mobility apparatus MLT 2 as shown in FIG. 2.

The second mobility apparatus MLT 2 may include a frame FRM, a second left-wheel LW placed on the left of the frame FRM, a second right-wheel RW placed on the right of the frame FRM, a second left-driving motor LM for providing a driving force to the second left-wheel LW, a second right-driving motor RM for providing a driving force to the second right-wheel RW, and a second controller Ctrl 2.

The second high-voltage battery SB may be fixedly provided in the second mobility apparatus MLT 2, but the present disclosure is not limited thereto. The second high-voltage battery SB may be detachably placed in the second mobility apparatus MLT 2. The second high-voltage battery SB mounted in the frame FRM with a fully-discharged SoC status may be removed, and replaced with a new second high-voltage battery SB with a full-charged SoC status.

When the second high-voltage battery SB is fixedly mounted in the second mobility apparatus MLT 2, the second mobility apparatus MLT 2 may include a charging connector for charging the second high-voltage battery SB.

The frame FRM may form the exterior of the second mobility apparatus MLT 2 and accommodate other components.

The frame FRM may include a second pivot mechanism PM2 as a second connection mechanism, and the second pivot mechanism PM2 may be detachably pivot-connected to a first pivot mechanism PM1 which is a first connection mechanism fixed to the body of the first mobility apparatus MLT1.

The first pivot mechanism PM1 may include an extension rod ER extending from the body of the first mobility apparatus MLT 1 rearwardly, and a pivot pin PN upwardly protruding from the end of the extension rod ER.

The second pivot mechanism PM2 may include an extension unit EP in a triangle shape, which is straightforwardly protruding from the frame FRM of the second mobility apparatus MLT 2, and a pivot ring PR into which the pivot pin PN is rotatably inserted from the end of the extension unit EP.

The pivot pin PN may be limited in linear movement while being inserted into the pivot ring PR, but may rotate with respect to a Z-axis direction in FIG. 2. Therefore, while being pivot-connected, the second mobility apparatus MLT 2 may be limited in linear movement with regard to the first mobility apparatus MLT 1 based on the pivot connection point, but may rotate with respect to the z-axis.

When driving in the forward direction, i.e. in the X-axis direction, the first mobility apparatus MLT 1 and the second MLT 2 may maintain straight driving without separate steering control for the second mobility apparatus MLT 2.

An embodiment of the present disclosure may include a pivot mechanism as first and second connection mechanisms, but the present disclosure is not limited thereto. For example, the first and second mechanisms may be known mechanisms that implements a non-rotational connection with respect to the Z-axis.

The second left-driving motor LM may include a rotational axis connected to the second left-wheel LW to provide a driving force to the second left-wheel LW.

The second right-driving motor RM may include a rotational axis connected to the second right-wheel RW to provide a driving force to the second right-wheel RW.

The second left-wheel LW and the second right-wheel RW may be respectively connected to the second left-driving motor LM and the second right-driving motor RM, thereby enabling independent driving from each other.

The second left-driving motor LM and the second right-driving motor RM may drive in the forward direction and in the reverse direction, respectively. When driven in the forward direction, the second mobility apparatus MLT 2 may travel in the forward direction, and when driven in the reverse direction, the second mobility apparatus MLT 2 may travel in the rear direction.

For example, the second left-driving motor LM and the second right-driving motor RM each may be implemented in an in-wheel driving system where each driving motor is provided in wheels, but the present disclosure is not limited thereto.

Unlike an embodiment, the second mobility apparatus MLT 2 may not operate independently on the left and right, but the driving force of a single common motor may be delivered into the second left-wheel LW and the second right-wheel RW. For this, a vehicle gear may be included between the common second driving motor, the second left-wheel LW, and the second right-wheel RW. The driving force of the second driving motor may be divided by the vehicle gear and transmitted to the second left-wheel LW and the second right-wheel RW. A toque vectoring means may be added for torque distribution between the second left-wheel LW and the second right-wheel RW.

Referring to FIG. 2, the second controller Ctrl 2 may control the second left-driving motor LM and the second right-driving motor RM to achieve forward driving and reverse driving of the second mobility apparatus MLT 2. The second controller Ctrl2, when the steering of the second mobility apparatus MLT 2 is needed, may change the driving direction of the second mobility apparatus MLT 2 by controlling respective toques or the rotation numbers of the second left-driving motor LM and the second right-driving motor RM. Through the independent control of driving of the second left-driving motor LM and the second right-driving motor RM, the steering of the second mobility apparatus MLT2 may be ensured without a separate steering device.

Wired and wireless communication means may be included to deliver information between connectors in FIG. 1, the first mobility apparatus MLT 1, and the second mobility apparatus MLT 2.

According to an embodiment of the present disclosure, the first controller Ctrl 1 or the second controller Ctrl 2 may include a memory and a processor. The memory may store computer commanders for performing the functions of the controller, and the processor may perform the functions by loading and executing the commands from the memory.

The memory may include at least one of hard disk drive (HDD), solid-state drive (SDD), silicon disk drive (SDD), ROM, RAM, compact disc ROM (CD-ROM), magnetic tape, floppy disk, and optical data storage device.

The processor may include at least one of a computer, a microprocessor, a central processing unit (CPU), an ASIC, an electric circuit, and a logic circuit.

The first connector C1 and the second connector C2 of the first mobility apparatus MLT1 may be connected to the third connector C3 and the fourth connector C4 of the second mobility apparatus MLT2. As a signal transmission connector is connected, the first mobility apparatus MLT 1 and the second mobility apparatus MLT 2, i.e. the first controller Ctrl 1 and the second controller Ctrl2 may communicate with each other.

When the first mobility apparatus MLT 1 and the second mobility apparatus MLT 2 are mechanically and electrically connected, and the first mobility apparatus MLT 1 starts the forward driving, the second controller Ctrl 2 may perform the straightforward driving of the second mobility apparatus MLT 2 by controlling the second left-driving motor LM and the second right-driving motor RM according to the signal received from the first connector C1.

Part or all of the speed, gear position, steering angle, accelerator pedal sensor (APS) information, and brake pedal sensor (BPS) information of the first mobility apparatus MLT 1 may be transmitted to the second mobility apparatus MLT 2.

The second controller Ctrl 2 of the second mobility apparatus MLT 2 may determine whether the first mobility apparatus MLT 1 operates in the forward direction or in the reverse direction by using part or all of the speed, the gear position, the APS information, and the BPS information of the first mobility apparatus MLT 1. However, the present disclosure is not limited thereto, but it may be possible to directly receive information on whether the first mobility apparatus operates in the forward direction or in the reverse direction from the first controller Ctrl 1.

When the first mobility apparatus MLT 1 operates in the forward direction, the second controller Ctrl 2 may drive the second left-driving motor LM and the second right-driving motor RM in the forward direction to allow the second mobility apparatus MLT 2 to operate in the straightforward direction. When the first mobility apparatus MLT 1 operates in the reverse direction, the second controller Ctrl 2 May drive the second left-driving motor LM and the second right-driving motor RM in the reverse direction to allow the rear-driving of the second mobility apparatus MLT2.

The second controller Ctrl 2 may determine the steering status based on steering angle information on the first mobility apparatus MLT 1 and perform the steering of the second mobility apparatus MLT 2 accordingly.

The second mobility apparatus MLT 2 may not include a separate steering device such as a steering wheel, a steering rack, and the like, but may perform the steering through torque control of the second left-driving motor LM and second right-driving motor RM.

The second controller Ctrl 2 may calculate a driving torque for driving and a steering torque for steering for each of the second left-driving motor LM and the second right-driving motor RM to use for control.

For example, for the steering of the second mobility apparatus MLT 2, the steering torque value of the second left-driving motor LM and the second right-driving motor RM according to the steering angle of the first mobility apparatus MLT 1 may be included in a look-up table or a calculation program.

While driving in a straightforward direction, the speed of the second mobility apparatus MLT 2 may be controlled not to exceed the speed of the first mobility apparatus MLT 1. The pivot connection between the first mobility apparatus MLT 1 and the second mobility apparatus MLT 2 may be within a predetermined pivot angle. For example, while driving in the straightforward direction, when the speed of the second mobility apparatus MLT 2 is equal to or smaller than the speed of the first mobility apparatus MLT 1, the pivot angle of the second mobility apparatus MLT 2 with respect to the first mobility apparatus MLT 1 from the pivot connection point may be 0 degrees (an angle at which the first mobility apparatus MLT 1 and the second mobility apparatus MLT 2 are in a straight line).

While driving in the forward direction, the second mobility apparatus MLT 2 may be controlled to follow the first mobility apparatus MLT 1, thereby achieving continued and smooth driving of a plurality of mobilities.

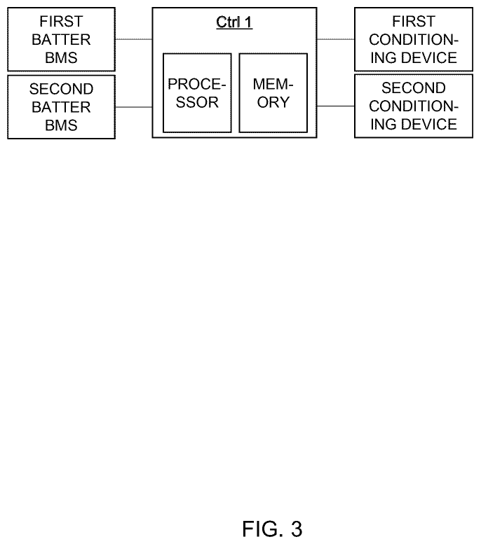

Referring to FIG. 3, the first controller Ctrl 1 may receive information from the BMS of the first high-voltage battery MB and the BMS of the second high-voltage battery SB, determine whether the first high-voltage battery MB and the second high-voltage battery SB need conditioning, and perform the conditioning accordingly. The description thereof is detailed below.

The first controller Ctrl 1 may include a memory that stores a computer program for controlling the conditioning and a processor for executing the program.

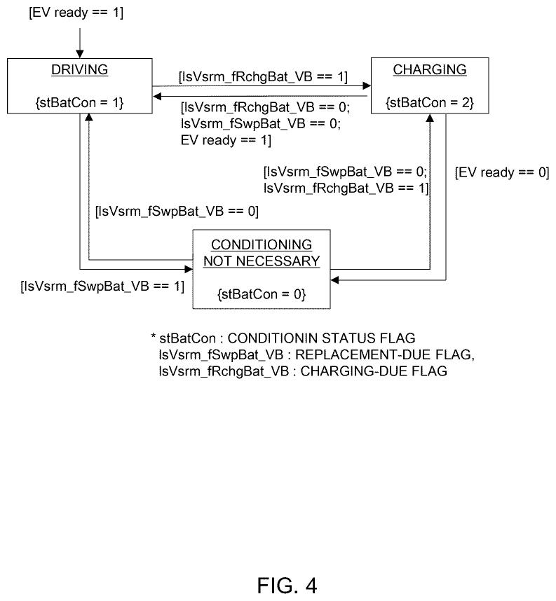

The first controller Ctrl 1 may determine whether the first high-voltage battery MB and the second high-voltage battery SB need conditioning through execution of the program by the processor. The description thereof is detailed with reference to FIG. 4.

According to an embodiment, the first controller Ctrl 1 may determine the value of a conditioning status flag according to whether conditioning is required. For example, when the conditioning is not required, a flag value may be determined as ‘0’, when the conditioning is required for the power supply of the first driving motor, the flag value may be determined as ‘1’, and when the conditioning is required since the charging is due, the flag value may be determined as ‘2’.

The conditioning status of each high-voltage battery may vary depending on the situation, and the first controller Ctrl 1 may determine and store a conditioning status flag according to the situation.

For example, in FIG. 4, when the driving use is scheduled, the class of the conditioning status flag may be determined and stored as ‘1’. When the charging is scheduled, the flag value may be updated to class ‘2’. When replacement is scheduled in the second high-voltage battery SB, the flag value may be updated from class ‘1’ to class ‘0’.

When the charging is scheduled and the flag value is updated to class ‘2’, after the charging is completed and the use is due, the flag value may be updated to class ‘1’. When the engine of the first mobility apparatus MLT 1 is turned off, i.e. EV ready status is turned off, the flag value may be updated to class ‘0’.

When the flag value is class ‘0’ since the conditioning is not required and charging is scheduled, the flag value may be updated to class ‘2’. When the replacement is completed and the use is due for the second high-voltage battery SB, the flag value may be updated to class ‘1’.

The first controller Ctrl 1 may determine the conditioning status flag of each of the first high-voltage battery MB and the second high-voltage battery SB according to the status such as driving use due, charging due, replacement due statuses, and the like.

The first controller Ctrl 1 may determine a conditioning time point according to the conditioning status flag, and transmit a control signal for conditioning to a first conditioning device and a second conditioning device to perform conditioning accordingly.

The first conditioning device may perform the conditioning of the first high-voltage battery MB, and the second conditioning device may perform the conditioning of the second high-voltage battery SB.

The conditioning device may include a cooling device for cooling a high-temperature state of the high-voltage battery and a heating device for adding heat to a high-voltage battery at a low temperature to increase the temperature.

The cooling device may include at least one of an air cooling device including a blower fan, and a water cooling device including a coolant flow path and a pump.

The heating device may include a heater to increase the temperature of the high-voltage battery directly or indirectly.

The second conditioning device may be placed in the second mobility apparatus MLT 2, and controlled by the second controller Ctrl 2 or the first controller Ctrl 1. For example, the first controller Ctrl 1 may transmit a control signal for controlling the second conditioning device to the second controller Ctrl 2, and the second controller Ctrl 2 may control the second conditioning device according to the control signal. The first controller Ctrl 1 may directly transmit the control signal for controlling the second conditioning device to the second conditioning device to perform conditioning control.

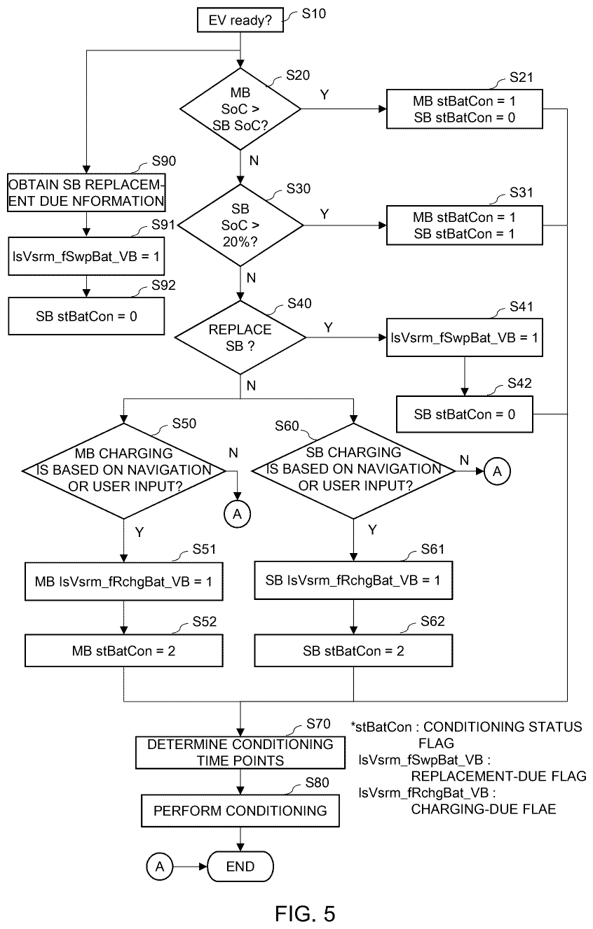

FIG. 5 is a view illustrating a battery conditioning control process according to an embodiment. The description thereof is detailed below.

The first controller Ctrl 1 may identify whether a vehicle state is ‘EV Ready’ at step S10. The ‘EV Ready’ may be determined by the operation of a start switch. In the case of electric vehicles, ‘EV Ready’ may indicate that ‘Start’ button is pressed. When the gear is in ‘D’ and the driver releases a brake, the first mobility apparatus MLT 1 may start right away by the driving of the first driving motor.

The first controller Ctrl 1 may compare the SoC of the first high-voltage battery MB with the SoC of the second high-voltage battery SB at step S20.

When it is determined that the SoC of the first high-voltage MB is greater than the SoC of the second high-voltage battery SB at step S20, the first controller Ctrl 1 may determine the driving use of the first high-voltage battery MB, determine the conditioning status flag of the first high-voltage MB as class ‘1’, and determine the conditioning status flag of the second high-voltage battery SB as class ‘0’ at step S21.

In N (i.e., No) of step S20, the first controller Ctrl 1 may compare the SoC of the second high-voltage battery SB with the SoC of a first setting at step S30. According to an embodiment, the SoC of the first setting may be 20%, but it is not limited thereto.

When it is determined that the SoC of the second high-voltage battery SB is greater than the SoC of the first setting at step S30, the first controller Ctrl 1 may determine the driving use of the first high-voltage battery MB and the second high-voltage battery SB, determine the conditioning status flag of the first high-voltage battery MB as class ‘1’, and determine the conditioning status flag of the second high-voltage battery SB as class ‘1’ at step S31.

When it is determined that the SoC of the second high-voltage battery SB is equal to or smaller than the SoC of the first setting at step S30, the first controller Ctrl 1 may request a user to decide on whether to change the second high-voltage battery SB. For example, a pop-up window requesting a decision on whether to replace the second high-voltage battery SB may be output on the AVN screen.

In Y (i.e., Yes) of step S40, when the replacement is determined according to the user input on the pop-up window, the first controller Ctrl 1 may determine the replacement due flag as class ‘1’ at step S41, and the conditioning status flag of the second high-voltage battery SB as class ‘0’ at step S42.

In N at step S40, when it is determined that the second high-voltage battery SB is not replaced at step S40, the first controller Ctrl 1 may perform steps S50 and S60.

At step S50, the first controller Ctrl 1 may identify whether the first high-voltage battery MB is due to charging.

A navigation device may determine whether to charge based on information on the charging station that is closest to the current location or has the lowest rate on the driving route to the destination or regardless of the route. The navigation device may output a pop-up window for requesting a decision on whether to determine the charging based on the SoC of the first high-voltage battery BM and/or the SoC of the second high-voltage battery SB on the AVN screen and receive the decision from the user.

At step S50, the first controller Ctrl 1 may determine whether the first high-voltage battery MB is due for charging based on the navigation device or the user input.

In Y at step S50, when the charging of the first high-voltage battery MB is scheduled, the first controller Ctrl 1 may determine the charging due flag of the first high-voltage battery MB as class ‘1’ at step S51.

At step S52, the first controller Ctrl 1 may determine the conditioning status flag of the first high-voltage battery MB as class ‘2’.

At step S60, the first controller Ctrl 1 may determine whether the second high-voltage battery SB is due for charging based on the navigation device or the user input.

In Y at step S60, when the charging of the second high-voltage battery SB is scheduled, the first controller Ctrl 1 may determine the charging due flag of the second high-voltage battery SB as class ‘1’ at step S61.

At step S62, the first controller Ctrl 1 may determine the conditioning status flag of the second high-voltage battery SB as class ‘2’.

Unlike steps S30 and S40, whether to replace the second high-voltage battery SB may be determined by the user input although the SoC of the second high-voltage battery SB is not lower than the SoC of the first setting.

The first controller Ctrl 1 may obtain the replacement due information at step S90, determine the replacement due flag of the second high-voltage battery SB as class ‘1’ at step S91, and determine the conditioning status flag of the second high-voltage battery SB as class ‘0’ at step S92.

When the conditioning status flag of each of the first high-voltage battery MB and the second high-voltage battery SB is determined, the first controller Ctrl 1 may determine each conditioning time point at step S70.

The start point of conditioning may be determined by selecting the most effective status in consideration of the SoH, temperature, and the like of the battery that needs conditioning and calculating the time required to ensure the status.

At step S80, the first controller Ctrl 1 may transmit the control signal including the conditioning status flag information to the first conditioning device and/or the second conditioning device to perform the conditioning.

The conditioning for driving use and the conditioning for charging may be different. For example, when the optimal status for driving use of the battery is a first state, and the optimal status for charging is a second state, the conditioning may be performed targeting the first state as the conditioning status flag is class ‘1’, and the conditioning may be performed targeting the second state as the conditioning status flag is class ‘2’.

In the conditioning device, the control for conditioning targeting the first state may be different from the control for conditioning targeting the second state.

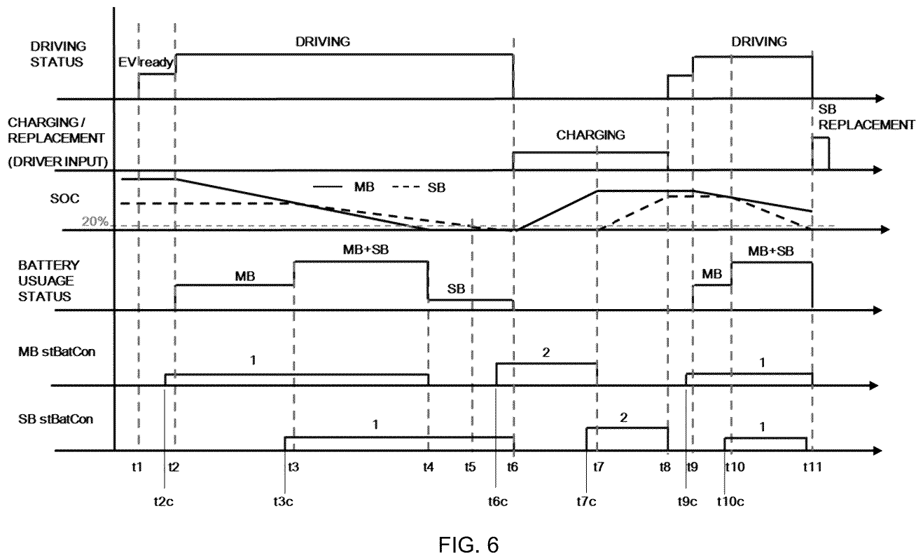

FIG. 6 is a view illustrating a decision on the conditioning flag when the second mobility apparatus MLT 2 is connected to the first mobility apparatus MLT 1 to operate.

The first mobility apparatus MLT 1 may be in EV Ready at time t1, and may start driving at time t2.

Since the driving use of the first high-voltage battery MB is scheduled at time t2, the conditioning status flag may be class ‘1’.

The first controller Ctrl 1 may determine a conditioning start point t2c of the first high-voltage battery MB to perform the conditioning.

When reaching time t3, both the first high-voltage battery MB and the second high-voltage SB may be in a driving use status. The first controller Ctrl 1 may determine the conditioning flag of the second high-voltage battery SB as class ‘1’, and the conditioning start point t3c to perform the conditioning.

At time t4, the first high-voltage battery MB may be fully discharged, and only the second high-voltage battery SB may be in the driving use status.

When reaching time t5, the second high-voltage battery SB may reach the SoC of the first setting of 20%. The first controller Ctrl 1 may request a user to decide whether to charge and/or replace the second high-voltage battery SB through the AVN screen.

At time t6, as the charging of the first high-voltage battery MB is scheduled, the first controller Ctrl 1 may determine the conditioning status flag of the first high-voltage battery MB as class ‘2’, and a conditioning start point toc to perform the conditioning.

At time t7, as the charging of the second high-voltage battery SB is scheduled, the first controller Ctrl 1 may determine the conditioning status flag of the second high-voltage battery SB as class ‘2’, and a conditioning start point of t7c to perform the conditioning.

At time t7, the charging of the first high-voltage battery MB may be completed, and at time t8, the charging of the second high-voltage battery SB may be completed.

At time t9, as the driving use of the first high-voltage battery MB is scheduled, the first controller Ctrl 1 may update the conditioning flag of the first high-voltage battery MB as class ‘1’, and determine a conditioning start point toc to perform the conditioning.

At time t10, as the driving use of the second high-voltage battery SB is scheduled, the first controller Ctrl 1 may update the conditioning flag of the second high-voltage battery SB as class ‘1’, and determine a conditioning start point t10c to perform the conditioning.

At time t11, as the driving use of the second high-voltage battery SB is scheduled, the first controller Ctrl 1 may update the conditioning flag of the second high-voltage battery SB as class ‘0’.

When the SoC of the first high-voltage battery MB and the SoC of the second high-voltage battery SB are fully discharged, the conditioning flag may be updated to class ‘0’.

In conditioning the first high-voltage battery MB and the second high-voltage battery SB, the required power may be provided by using battery power when any one of the first high-voltage battery MB and the second high-voltage battery SB is in use or in charging, thereby improving the efficiency.

For example, since the second high-voltage battery SB is in driving use at a conditioning start point toc of the first high-voltage battery MB, the conditioning of the first high-voltage battery MB may be performed by using the power of the second high-voltage battery SB.

Since the first high-voltage battery MB is in charging at a conditioning start point t7c, i.e. at the conditioning start point for charging the second high-voltage battery SB, the conditioning of the second high-voltage battery SB may be performed by using the power of the first high-voltage battery MB.

Since the first high-voltage battery MB in driving use at a conditioning start point t10c, i.e. at the conditioning start point of driving use of the first high-voltage battery MB, the conditioning of the second high-voltage battery SB may be performed by using the power of the first high-voltage battery MB.

What is claimed is:

1. A method for conditioning a battery of a mobility apparatus including a plurality of wheels, at least one driving motor for providing a driving force to the plurality of wheels, a power system including a first battery for supplying power to the at least one driving motor, and a controller for controlling the at least one driving motor and the power system, the method comprising:
determining, by the controller, whether the first battery and a second battery detachably and electrically connected to the power system require conditioning;
determining, by the controller, one or more conditioning time points of the first battery and/or the second battery based on a determination of whether the first battery and the second battery require the conditioning; and performing, by the controller, the conditioning of the first battery and/or the second battery, wherein performing the conditioning of the first battery and/or the second battery includes transmitting a control signal to a first conditioning device and/or a second conditioning device.

2. The method as claimed in claim 1, wherein determining whether the first battery and the second battery require the conditioning is performed based on at least one of charging due information of the first battery, charging due information of the second battery, state of charging (SoC) information of the first battery, SoC information of the second battery, or replacement due information of the second battery.

3. The method as claimed in claim 2, wherein determining whether the first battery and the second battery require the conditioning comprises a first step of determining whether the first battery and the second battery require the conditioning based on a result of comparison between a SoC of the first battery and a SoC of the second battery.

4. The method as claimed in claim 3, wherein determining whether the first battery and the second battery require the conditioning further comprises, a second step of determining whether the first battery and the second battery require the conditioning based on a result of comparison between the SoC of the second battery and a first preset SoC when the SoC of the first battery is equal to or less than the SoC of the second battery.

5. The method as claimed in claim 4, wherein determining whether the first battery and the second battery require the conditioning further comprises a third step of determining whether the second battery requires the conditioning based on the replacement due information of the second battery.

6. The method as claimed in claim 2, wherein determining whether the first battery and the second battery require the conditioning comprises obtaining the charging due information based on a navigation device or a user input.

7. The method as claimed in claim 6, wherein determining whether the first battery and the second battery require the conditioning further comprises determining that the first battery requires conditioning when the first battery is due for charging, and determining that the second battery requires the conditioning when the second battery is due for charging.

8. The method as claimed in claim 2, wherein determining whether the first battery and the second battery require the conditioning comprises determining a first conditioning flag for the first battery and/or a second conditioning flag for the second battery differently based on the charging due information, the SoC information, and the replacement due information.

9. The method as claimed in claim 8, wherein performing the conditioning comprises transmitting the control signal including the first conditioning flag and/or the second conditioning flag.

10. The method as claimed in claim 1, wherein the second battery is detachably and electrically connected to the first battery through a DC/DC converter.

11. A mobility apparatus, comprising:
a plurality of wheels;
at least one driving motor configured to provide a driving force to the plurality of wheels;
a power system including a first battery for providing power to the at least one driving motor; and
a controller configured to control the at least one driving motor and the power system,
wherein when a second battery is detachably and electrically connected to the power system, the controller is configured to:
determine whether the first battery and the second battery require conditioning,
determine one or more conditioning time points of the first battery and/or the second battery based on a determination of whether the first battery and the second battery require the conditioning, and
perform the conditioning of the first battery and/or the second battery by transmitting a control signal to a first conditioning device or a second conditioning device.

12. The mobility apparatus as claimed in claim 11, wherein the controller is configured to determine whether the first battery and the second battery require the conditioning based on at least one of charging due information of the first battery, charging due information of the second battery, state of charging (SoC) information of the first battery, SoC information of the second battery, or replacement due information of the second battery.

13. The mobility apparatus as claimed in claim 12, wherein in determining whether the first battery and the second battery require the conditioning, the controller is further configured to determine whether the first battery and the second battery require conditioning based on a result of comparison between a SoC of the first battery and a SoC of the second battery.

14. The mobility apparatus as claimed in 13, wherein in determining whether the first battery and the second battery require the conditioning, the controller is further configured to determine whether the first battery and the second battery require the conditioning based on a result of comparison between the SoC of the second battery and a first preset SoC when the SoC of the first battery is equal to or less than the SoC of the second battery.

15. The mobility apparatus as claimed in claim 14, wherein in determining whether the first battery and the second battery require the conditioning, the controller is further configured to determine whether the second battery requires conditioning based on the replacement due information of the second battery.

16. The mobility apparatus as claimed in claim 12, wherein in determining whether the first battery and the second battery require the conditioning, the controller is further configured to obtain the charging due information based on a navigation device or a user input.

17. The mobility apparatus as claimed in claim 16, wherein in determining whether the first battery and the second battery require the conditioning, the controller is further configured to:
determine that the first battery requires the conditioning when the first battery is due for charging; and
determine that the second battery requires the conditioning when the second battery is due for charging.

18. The mobility apparatus as claimed in claim 12, wherein in determining whether the first battery and the second battery require the conditioning, the controller is further configured to determine a first conditioning flag for the first battery and/or a second conditioning flag for the second battery differently according to the charging due information, the SoC information, and the replacement due information.

19. The mobility apparatus as claimed in claim 18, wherein in performing the conditioning, the controller is further configured to transmit a control signal including the first conditioning flag and/or the second conditioning flag.

20. The mobility apparatus as claimed in claim 11, wherein the second battery is detachably and electrically connected to the first battery through a DC/DC converter.
